(19) United States
(12) Patent Application Publication
(10) Pub. No.: US 2014/0361000 A1
(43) Pub. Date: Dec. 11, 2014

(54) GLOW PLUG

(71) Applicant: NGK SPARK PLUG CO., LTD., Nagoya-shi, Aichi (JP)

(72) Inventors: Gaku Hatano, Inuyama-shi (JP); Hiroyuki Suzuki, Kasugai-shi (JP)

(73) Assignee: NGK SPARK PLUG CO., LTD., Nagoya-shi, Aichi (JP)

(21) Appl. No.: 14/374,277

(22) PCT Filed: Mar. 27, 2013
(86) PCT No.: PCT/JP2013/059139

§ 371 Date: Jul. 24, 2014

(30) Foreign Application Priority Data
Mar. 28, 2012 (JP) 2012-075167

(51) Int. Cl. F23Q 7/00; F02P 19/02

(52) U.S. Cl. CPC F23Q 7/001; F02P 19/02
USPC 219/267

(57) ABSTRACT

A contact member (7) which has a cylindrical hole and whose outer circumferential surface has a contour swelling radially outward as viewed from a direction orthogonal to its axial direction is disposed between the wall surface of an axial bore (43) and a center shaft (3) at the rear end of a glow plug (1). The disposed contact member (7) is in contact with the wall surface of the axial bore (43) and the center shaft (3). A tubular insulation member (6) is disposed on the rear side of the contact member (7). The tan δ of dynamic viscoelasticity of the contact member (7) within a temperature range of 50° C. to 150° C. is 0.1 or greater.

### TECHNICAL FIELD

The present invention relates to a glow plug used, for example, at the time of start-up of a diesel engine.

### BACKGROUND ART

A glow plug used, for example, at the time of start-up of a diesel engine is such that a heater which has a heat-generating resistor at its forward end portion is held directly or indirectly at a forward end portion of a tubular metallic shell having an axial bore. A rod-shaped center shaft is inserted into the axial bore of the metallic shell and disposed in a condition electrically insulated from the metallic shell. One end portion of the center shaft is connected to a rear end portion of the heater, and the other end portion projects from the rear end of the metallic shell. Two electrodes connected to the heat-generating resistor are electrically connected to the metallic shell and the center shaft, respectively. At the rear end of the axial bore, an annular contact member is disposed between the wall surface of the axial bore and the center shaft in order to maintain the gastightness of the interior of the axial bore of the metallic shell.

Diesel engines in which glow plugs having the above-described structure are used have conventionally been indirect injection diesel engines. However, in recent years, indirect injection diesel engines have been gradually replaced with direct injection diesel engines, in order to meet the demand for smaller size, higher fuel efficiency, and higher output. This may result in a change in structure of mounting glow plugs onto an engine, and glow plugs have been demanded to have a smaller diameter and a greater length.

When the overall length of a glow plug increases, the natural frequency of its center shaft decreases, which increases the possibility that the frequency of vibratory load produced as a result of operation of a diesel engine coincides with the natural frequency of the center shaft. Namely, resonance of the center shaft may occur frequently. When the center shaft resonates, a portion of the center shaft corresponding to the loop or antinode of vibration may come into contact with the inner circumferential surface of the metallic shell, resulting in a failure to maintain the insulation between the center shaft and the metallic shell. When the amplitude of vibration of the center shaft increases, the degree of bending of the center shaft increases, and the center shaft may break.

A glow plug which overcomes the above-mentioned problem is known (see, for example, Patent Document 1). In the known glow plug, a tube formed of insulating silicone is disposed in the gap between the center shaft and the metallic shell, and the center shaft is accommodated inside the tube. In this glow plug, the tube limits the amplitude of vibration of the center shaft when the center shaft resonates. As a result, the glow plug can prevent breakage of the center shaft, and can prevent contact between the metallic shell and the center shaft.

### PRIOR ART DOCUMENT

### Patent Document

Patent Document 1: Japanese Patent Application Laid-Open (kokai) No. 2007-51861

### SUMMARY OF THE INVENTION

However, the invention disclosed in Patent Document 1 still has a possibility that when the center shaft resonates, vibration is generated at a position along the center shaft where a contact member is disposed. Due to this vibration, an instantaneous load acts on the contact member in the radial direction of the contact member, and the contact member may deteriorate (e.g., may deform). The radial direction of the contact member is a direction away from the axis of the contact member on a plane orthogonal to the axial direction of the contact member.

An object of the present invention is to provide a glow plug which decreases the amplitude of vibration of a center shaft at the time of resonating, to thereby prevent deterioration of a contact member.

A glow plug according to a mode of the present invention comprises a heater which has a heat-generating resistor in a forward end portion thereof, the heat-generating resistor generating heat when energized; a tubular metallic shell which has an axial bore extending in a direction of an axis of the metallic shell and which directly or indirectly holds the heater in a forward end portion of the metallic shell; a rod-shaped center shaft which is disposed in the metallic shell such that a gap is formed between the center shaft and an inner circumferential surface of the metallic shell, the center shaft having a forward end portion connected to a rear end portion of the heater, and a rear end portion projecting from a rear end of the metallic shell; and an annular contact member which is formed of an insulating viscoelastic material and which is inserted into the axial bore at a rear end portion of the axial bore and is disposed in a state in which the contact member is in contact with the inner circumferential surface of the metallic shell and the center shaft, wherein the tan δ of dynamic viscoelasticity of the contact member within a temperature range of 50° C. to 150° C. is equal to or greater than 0.1.

In the present mode, when the tan δ of dynamic viscoelasticity of the contact member is equal to or greater than 0.1, the vibration prevention performance of the contact member is greatly enhanced. Namely, even when vibration acts on the glow plug and the center shaft resonates, the amplitude of vibration of the center shaft is greatly suppressed, because the contact member absorbs the vibration to a sufficient degree. Since the amplitude of vibration is greatly decreased at the position where the contact member is disposed, the instantaneous load acting on the contact member in the radial direction decreases, and deterioration, such as deformation, of the contact member can be prevented.

In the present embodiment, the contact member may have a rubber hardness of 80 to 100. In the case where the rubber hardness of the contact member is equal to or greater than 80, when the contact member is inserted into the gap between the center shaft and the inner circumferential surface of a rear end portion of the metallic shell, the contact member deforms by a smaller amount as compared with the case where the rubber hardness of the contact member is less than 80, and the contact member is not caught in the vicinity of the opening portion of the axial bore. Therefore, the load in the axial direction required to insert the contact member can be decreased greatly as compared with the case where the rubber hardness of the contact member is less than 80, whereby the degree of easiness of the operation of attaching the contact member can be increased.

In the present mode, a vibration prevention member which is provided separately from the contact member and whose tan δ of dynamic viscoelasticity within a temperature range of 50° C. to 150° C. is equal to or greater than 0.1 may be disposed in the above-mentioned gap. By disposing a vibration prevention member whose tan δ of dynamic viscoelasticity is equal to or greater than 0.1 to extend from a forward end portion of the center shaft to the position where the contact member is disposed, the amplitude of vibration of the center shaft at the time of resonating can be suppressed further.

In the present mode, at least a portion of the vibration prevention member may be disposed in a region between the contact member and a center position between a forward end of the ceramic heater and a rear end of the center shaft in the direction of the axis. When the center shaft resonates, the loop of vibration is produced in a region extending from the center position between the forward end of the heater and the rear end of the center shaft to the position where the contact member is disposed. By disposing the vibration prevention member, whose tan δ of dynamic viscoelasticity is equal to or greater than 0.1, in the gap between the center shaft and the metallic shell in the vicinity of the position of the loop of vibration such that the vibration prevention member comes into contact with the center shaft, the vibration prevention function of the vibration prevention member can be enhanced.

In the present mode, the contact member may be mainly formed of fluorocarbon rubber. The glow plug in this case can secure the heat resistance and insulating performance of the contact member sufficiently because the contact member is mainly formed of fluorocarbon rubber. Notably, the sentence “the contact member is mainly formed of fluorocarbon rubber” means that the fluorocarbon rubber content of the contact member is equal to or greater than 50%.

In the present mode, a contour of one of two cross sections of the contact member obtained by cutting the contact member in a state prior to attachment to the glow plug by a plane which contains a second axis which is the axis of the contact member may have a first contour segment assuming the form of a curve extending along the second axis and swelling radially outward with a radius R1 of curvature, and a second contour segment assuming the form of a straight line extending along the second axis or the form of a curve extending along the second axis and swelling radially inward with a radius R2 of curvature which satisfies a relational expression R1<R2. In the glow plug in this case, the second contour segment having the radius R2 of curvature extends along the second axis with a radius of curvature greater than that of the first contour segment having the radius R1 of curvature. Thus, when the contact member is pressed in along the second axis during assembly of the glow plug, the second contour segment can function as a core which supports the entire contact member and restrains the contact member from bending and being dragged inward. Accordingly, in the glow plug, the contact member is restrained from bending or wrinkling at the second contour segment. The contact member comes into contact with two members (two surfaces); i.e., the wall surface of the axial bore of the metallic shell and the center shaft. Therefore, the gastightness of the space surrounded by the wall surface of the axial bore of the metallic shell is secured by the contact member. As compared with the case where the gastightness of the space surrounded by the wall surface of the axial bore of the metallic shell is secured by forming a complicated seal surface on at least one of the metallic shell and the center shaft, the glow plug can be easily machined and can reduce cost.

### BRIEF DESCRIPTION OF THE DRAWINGS

FIG. 1 Longitudinal sectional view of a glow plug 1.

FIG. 2 Longitudinal sectional view on an enlarged scale of a rear end portion of the glow plug 1.

FIG. 3 Perspective view of a contact member 7 in a state prior to attachment to the glow plug 1.

FIG. 4 View showing, perspectively and in section, the contact member 7 in a state prior to attachment to the glow plug 1.

FIG. 5 Longitudinal sectional view showing a state in which the contact member 7 passes through a connection end portion 36 in a process of attaching the contact member 7 to the glow plug 1.

FIG. 6 Longitudinal sectional view showing a state in which the contact member 7 passes through a forward end position B2 of a taper portion 47 in the process of attaching the contact member 7 to the glow plug 1.

FIG. 7 Longitudinal sectional view showing a state in which the contact member 7 is pressed into the taper portion 47 in the process of attaching the contact member 7 to the glow plug 1.

FIG. 8 Longitudinal sectional view of the glow plug 1 in the case where a vibration prevention member 90 is attached to an intermediate trunk portion 33 and a rear end portion 32 of a center shaft 3.

FIG. 9 Graph showing the relation between the amplitude of loop of vibration of the center shaft 3 at the time of first resonance and the tan δ of dynamic viscoelasticity of the contact member 7.

FIG. 10 Graph showing the relation between the amplitude of vibration of the center shaft 3 at the time of first resonance and the tan δ of dynamic viscoelasticity of the contact member 7.

FIG. 11 Graph showing the relation between the amplitude of vibration of the center shaft 3 at the time of second resonance and the tan δ of dynamic viscoelasticity of the contact member 7.

FIG. 12 Graph showing the relation between insertion amount and load (in the direction of the axis O) required to insert the contact member 7 into the taper portion 47 for each of different rubber hardness of the contact member 7.

FIG. 13 Schematic view of a measurement system 16.

### MODES FOR CARRYING OUT THE INVENTION

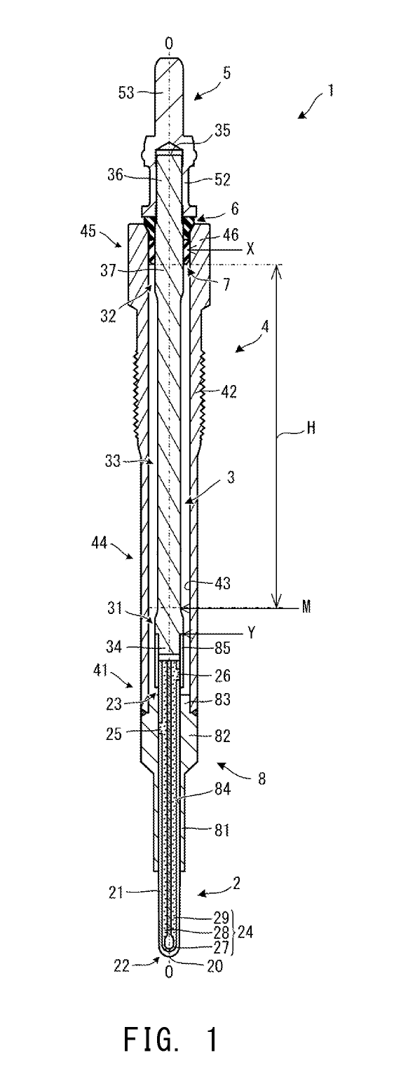

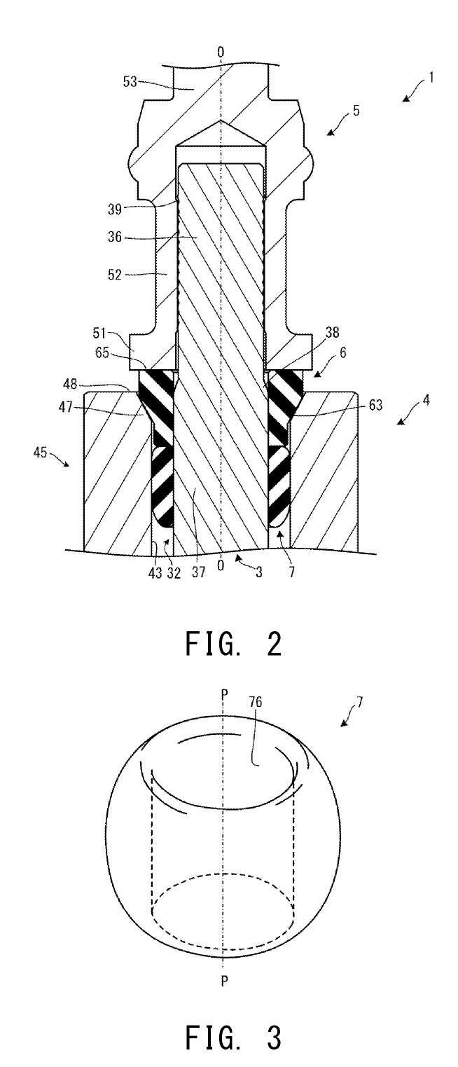

A glow plug according to an embodiment of the present invention will next be described with reference to the drawings. The entire structure of a glow plug 1 is described, by way of example, with reference to FIGS. 1 and 2. The drawings referred to herein are used for explaining technical features which the present invention can employ, and the configuration, etc., of the glow plug appearing in the drawings are given by way of illustration and not of limitation. In the following description, the axis of a metallic shell 4 is referred to as the axis O, and the axis O serves as reference in describing the positional relationship, orientations, and directions of those component members of the glow plug 1 which are attached to the metallic shell 4. With respect to the extending direction of the axis O (hereinafter, may be referred to as “the direction of the axis O”), a side on which a ceramic heater 2 is disposed (the lower side in FIG. 1) is referred to as the forward side of the glow plug 1. A direction away from the axis O on a plane orthogonal to the axis O is defined as a radially outward direction. A direction toward the axis O on the plane orthogonal to the axis O is defined as a radially inward direction. The radially outward direction and the radially inward direction are correctively referred to as the radial direction in the case where they are not distinguished from each other.

The glow plug 1 shown in FIG. 1 is attached to, for example, a combustion chamber of a direct-injection-type diesel engine (not shown), and is used as a heat source for assisting in ignition at start-up of an engine. The glow plug 1 mainly includes the metallic shell 4, a holding member 8, the ceramic heater 2, a center shaft 3, a connection terminal 5, an insulation member 6, the contact member 7, and a connection ring 85.

The ceramic heater 2 is described. The ceramic heater 2 includes a substrate 21 and a heat-generating element 24. The substrate 21 assumes the form of a round bar and is formed from an electrically insulating ceramic whose forward end portion 22 is formed into a hemispherical shape. The heat-generating element 24 is embedded in the substrate 21. The heat-generating element 24 is formed from an electrically conductive ceramic, and has a generally U-shaped section. The heat-generating element 24 includes a heat-generating resistor 27 and leads 28 and 29. The heat-generating resistor 27 is disposed in the forward end portion 22 of the ceramic heater 2 and is curved and bent at opposite ends in a shape resembling the letter U according to the curved surface of the forward end portion 22. The leads 28 and 29 are connected to opposite ends, respectively, of the heat-generating resistor 27 and extend substantially in parallel with each other toward a rear end portion 23 of the ceramic heater 2. The cross-sectional area of the heat-generating resistor 27 is smaller than that of each of the leads 28 and 29. Upon energization of the ceramic heater 2, heat is generated mainly by the heat-generating resistor 27. Electrode lead portions 25 and 26 project radially outward from the leads 28 and 29, respectively, at respective positions located rearward of the center of the ceramic heater 2. The electrode lead portions 25 and 26 are exposed at the outer circumferential surface of the ceramic heater 2 at positions deviated from each other in the direction of the axis O.

The holding member 8 is described. The holding member 8 is formed of a cylindrical tubular metal member extending in the direction of the axis O. The holding member 8 holds a trunk portion of the ceramic heater 2 within its cylindrical hole 84. The forward end portion 22 and the rear end portion 23 of the ceramic heater 2 project from the opposite ends of the holding member 8. A trunk portion 81 of the holding member 8 has a thick-walled flange portion 82 formed on a side toward the rear end thereof. The holding member 8 has a stepped shell engagement portion 83 which is located rearward of the flange portion 82 and is engaged with a forward end portion 41 of the metallic shell 4, which will be described later. Of the electrode lead portions 25 and 26 of the ceramic heater 2, the electrode lead portion 25 located on a side toward the forward end is in contact with the inner circumferential surface of the cylindrical hole 84 of the holding member 8, whereby the electrode lead portion 25 and the holding member 8 are electrically connected to each other.

Also, the tubular connection ring 85 of metal is press-fitted to the rear end portion 23 of the ceramic heater 2 projecting rearward from the shell engagement portion 83 of the holding member 8. The electrode lead portion 26 of the ceramic heater 2 is in contact with the inner circumferential surface of the connection ring 85. The electrode lead portion 26 and the connection ring 85 are electrically connected to each other. As a result of the forward end portion 41 of the metallic shell 4, which will be described later, being joined to the shell engagement portion 83 of the holding member 8, the electrode lead portion 25 is electrically connected to the metallic shell 4 via the holding member 8. The connection ring 85 connected to the electrode lead portion 26 is disposed within the metallic shell 4. Since the ceramic heater 2 and the metallic shell 4 are positioned by the holding member 8, the connection ring 85 and the metallic shell 4 are maintained in a mutually insulated condition.

The metallic shell 4 is described. The metallic shell 4 is a slender tubular metal member having an axial bore 43 extending therethrough in the direction of the axis O. The metallic shell 4 directly or indirectly holds the ceramic heater 2 at its forward end portion 41. Specifically, the inner circumference of the forward end portion 41 of the metallic shell 4 is engaged with the outer circumference of the shell engagement portion 83 of the above-mentioned holding member 8. The metallic shell 4 is electrically connected to the electrode lead portion 25 of the ceramic heater 2 via the holding member 8. Laser welding is performed along a region where the forward end portion 41 and the shell engagement portion 83 are mated, whereby the metallic shell 4 and the holding member 8 are joined together. The metallic shell 4 has an intermediate trunk portion 44 formed between the forward end portion 41 and the rear end portion 45. The intermediate trunk portion 44 extends long in the direction of the axis O, and has a mounting portion 42 formed on the outer circumferential surface of a portion located on a side toward the rear end. The mounting portion 42 has threads for mounting the glow plug 1 to an engine head of an internal combustion engine (not shown). A tool engagement portion 46 having a hexagonal cross section is formed on the rear side of the mounting portion 42. A tool used for mounting the glow plug 1 to the engine head is engaged with the tool engagement portion 46. As shown in FIG. 2, a taper portion 47 is formed on the wall surface of the axial bore 43 at the rear end portion 45 of the metallic shell 4 such that the diameter of the axial bore 43 decreases from the rear end 48 toward the forward side.

The center shaft 3 is described. As shown in FIG. 1, the center shaft 3 is a rod-shaped metal member extending in the direction of the axis O and is inserted into the axial bore 43 of the metallic shell 4. An intermediate trunk portion 33 of the center shaft 3 located between a forward end portion 31 and a rear end portion 32 of the center shaft 3 is smaller in outside diameter than the forward end portion 31 and the rear end portion 32. The center shaft 3 is disposed inside the metallic shell 4 such that a gap is formed between the center shaft 3 and the inner circumferential surface of the metallic shell 4. The forward potion 31 of the center shaft 3 is connected to a rear end portion of the ceramic heater 2. Specifically, the forward end portion 31 has a small-diameter ring engagement portion 34 formed at its forward end so as to be engaged with the inner circumference of the connection ring 85. As a result of the ring engagement portion 34 being engaged with the connection ring 85, the ceramic heater 2 and the center shaft 3 are unitarily connected together along the axis O via the connection ring 85. Although unillustrated, laser welding is performed along a region where the forward end portion 31 and the connection ring 85 are mated, whereby the forward end portion 31 and the connection ring 85 are joined together. Through this joining, the center shaft 3 is electrically connected to the electrode lead portion 26 of the ceramic heater 2 via the connection ring 85. As mentioned above, since the ceramic heater 2 and the metallic shell 4 are positioned by the holding member 8, the center shaft 3 and the metallic shell 4 are maintained in a mutually insulated state in the axial bore 43.

As shown in FIG. 2, the rear end portion 32 of the center shaft 3 has a connection end portion 36 and a connection base portion 37. The connection end portion 36 projects from the rear end 48 of the metallic shell 4. The connection base portion 37 connects the connection end portion 36 and the intermediate trunk portion 33. The connection end portion 36 has a lock portion 39 formed by knurling its outer circumferential surface. The connection end portion 36, including the lock portion 39, is smaller in outside diameter than the connection base portion 37. A shoulder portion 38 is formed between the connection end portion 36 and the connection base portion 37 for connecting, in a tapered manner, the connection end portion 36 and the connection base portion 37.

The contact member 7 and the insulation member 6 are disposed on the rear end portion 32 of the center shaft 3. The contact member 7 is disposed between the wall surface of the axial bore 43 of the metallic shell 4 and the connection base portion 37 of the center shaft 3. The contact member 7 holds the center shaft 3 in the axial bore 43 to thereby restrain vibration of the center shaft 3, and maintains the gastightness of the space surrounded by the wall surface of the axial bore 43. The details of the contact member 7 will be described later.

The insulation member 6 is a tubular member formed from a heat-resistant, electrically insulative material; for example, nylon (registered trademark), for preventing short circuit which could otherwise result from contact between the metallic shell 4 and the center shaft 3 or the connection terminal 5 (which will be described later). The rear end portion 32 of the center shaft 3 is inserted through the insulation member 6, and a taper portion 63 provided on its outer circumference is brought into contact with the taper portion 47 of the metallic shell 4, whereby the insulation member 6 is positioned. The insulation member 6 maintains the insulation between the metallic shell 4 and the center shaft 3. A rear end 65 of the insulation member 6 projects rearward from the rear end 48 of the metallic shell 4. A flange portion 51 (which will be described later) of the connection terminal 5 is in contact with the rear end 65. Therefore, the connection terminal 5 and the metallic shell 4 are maintained in a mutually insulated state.

The connection terminal 5 is fixed to the connection end portion 36 of the center shaft 3. The connection terminal 5 has a cap-like trunk portion 52 which is fitted externally to the connection end portion 36, and a pin-like protrusion 53 protruding rearward from the trunk portion 52. The trunk portion 52 has a flange portion 51 provided at its forward open end in such a manner as to project radially outward along the entire circumference. When the connection terminal 5 is fitted externally to the connection end portion 36 of the center shaft 3, the flange portion 51 comes into contact with the rear end 65 of the insulation member 6. In a state in which the connection terminal 5 is pressed forward with respect to the direction of the axis O, the trunk portion 52 is crimped radially inward. The inner circumferential surface of the trunk portion 52 is firmly locked to the lock portion 39 of the connection end portion 36. Since the lock portion 39 is knurled, as a result of crimping, the force of fixation of the trunk portion 52 to the lock portion 39 is increased, whereby the connection terminal 5 and the center shaft 3 are unitarily fixed. As a result of crimping, the connection terminal 5 and the center shaft 3 are electrically connected to each other.

As shown in FIG. 1, a plug cap (not shown) is fitted to the protrusion 53 of the connection terminal 5 when the glow plug 1 is mounted to the engine head (not shown). The heat-generating resistor 27 of the heat-generating element 24 of the ceramic heater 2 generates heat through application of electricity between the electrode lead portion 25 which is grounded to the engine via the holding member 8 and the metallic shell 4, and the electrode lead portion 26 which is connected to the plug cap via the connection terminal 5 and the center shaft 3.

The contact member 7 is described with reference to FIGS. 2 and 3. As mentioned above, the contact member 7 is an annular member which is inserted into the axial bore 43 at the rear end portion 45 of the axial bore 43, and is disposed in a state in which the contact member 7 is in contact with the wall surface of the axial bore 43 of the metallic shell 4 and the connection base portion 37 of the center shaft 3. The contact member 7 holds the center shaft 3 in the axial bore 43 to thereby restrain vibration of the center shaft 3, and maintains the gastightness of the space between the metallic shell 4 and the center shaft 3. As shown in FIG. 3, the contact member 7 has a cylindrical hole 76 extending in the extending direction of the axis P of the contact member 7 (hereinafter, also referred to as the “direction of the axis P”). The contour of the outer circumferential surface of the contact member 7 swells radially outward as viewed from a direction orthogonal to the direction of the axis P.

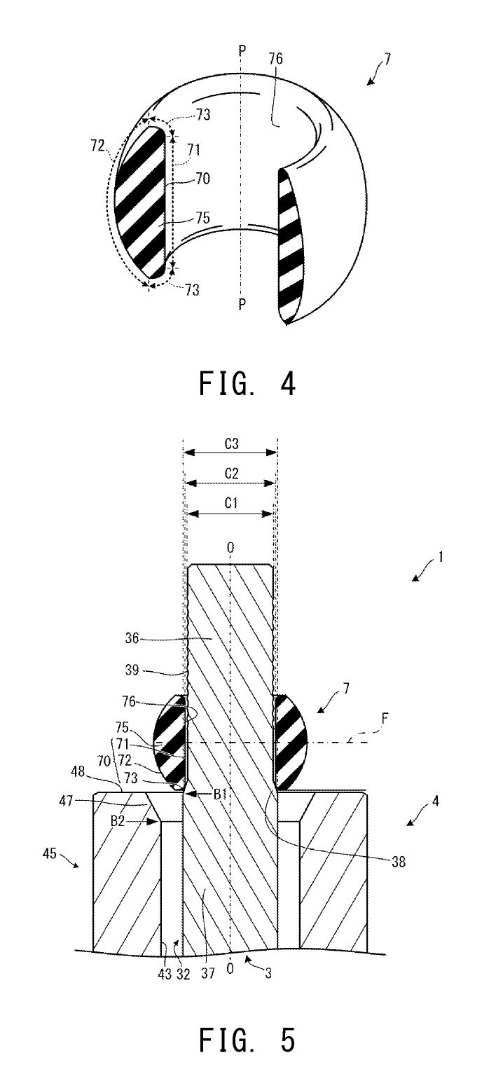

As shown in FIG. 4, the contact member 7 in a state prior to attachment to the glow plug has a shape which is symmetric (mirror image) with respect to the axis P. Namely, when the contact member 7 is cut (split) into two pieces by a plane which contains the axis P, each of the pieces has two cross sections which are substantially the same. The contact member 7 has a shape which is symmetric with respect to a plane F (see FIG. 5) which passes through the midpoint in the direction of the axis P. In the contact member 7 of the present embodiment, when attention is focused on one 75 of two cross sections of the piece, a contour 70 of the cross section 75 assumes the following form.

The contour 70 has three kinds of contour segments (line segments which constitute the contour); namely, a first contour segment 72, a second contour segment 71, and third contour segments 73. The first contour segment 72 assumes the form of a curve which has a radius R1 of curvature and extends along the axis P while swelling radially outward. The second contour segment 71 assumes the form of a straight line extending along the axis P or a curve which has a radius R2 of curvature and extends along the axis P while swelling radially inward. The radius R1 of curvature is smaller than the radius R2 of curvature. In the present embodiment, the second contour segment 71 is a straight line. The second contour segment 71 can be considered to be a curved contour segment whose radius R2 of curvature is infinite. The third contour segments 73 connect the first contour segment 72 and the second contour segment 71 at their ends located on the same side with respect to the axis P, and each of the third contour segments 73 assumes the form of a curve swelling radially inward. The connection points between the first contour segment 72 and the third contour segments 73 form upper and lower (forward and rear) ends of the contact member 7 with respect to the direction of the axis P.

The contact member 7 is formed of a viscoelastic material having heat-resistance and insulating properties, such as fluorocarbon rubber or silicone rubber. Preferably, the contact member 7 is mainly composed of fluorocarbon rubber. When the predominant component of the contact member 7 is fluorocarbon rubber, the contact member 7 can have sufficiently high heat-resistance and sufficiently high insulating performance. Preferably, the tan δ of dynamic viscoelasticity of the contact member 7 is 0.1 or greater. As shown in Example 1 to be described later, when the tan δ of dynamic viscoelasticity is less than 0.1, the vibration prevention function of the contact member 7 is insufficient. More preferably, the tan δ of dynamic viscoelasticity of the contact member 7 falls within a range of 0.1 to 1.0. When the tan δ increases, the viscosity of the contact member 7 becomes predominant over the elasticity of the contact member 7 and the degree of easiness of the operation of attaching of the contact member to the glow plug may decrease. In contrast, when the tan δ of dynamic viscoelasticity is set to a value equal to or less than 1, the degree of easiness of the operation of attaching the contact member 7 increases, as compared to the case where the tan δ of dynamic viscoelasticity is greater than 1. Preferably, the rubber hardness of the contact member 7 falls within a range of 80 to 100, and more preferably, is 80. The upper limit of the rubber hardness is 100. As shown in Example 3 to be described later, when the rubber hardness is equal to or greater than 80, the degree of easiness of the attachment operation increases. In contrast, when the rubber hardness is less than 80, the degree of easiness of the operation of attaching the contact member 7 decreases. The rubber hardness is measured in accordance with the procedure prescribed in JIS K6253 and by making use of, for example, an ASKER rubber hardness tester, model A (a product of KOBUNSHI KEIKI CO, LTD.) The similar condition is used in the following measurement.

The glow plug 1 is assembled as outlined below. A material composed of an electrically conductive ceramic powder, binder, etc., is injection-molded into an element green-body which is to become the heat-generating element 24 of the ceramic heater 2. An electrically insulating ceramic powder is die-pressed into substrate green-body halves which are collectively to become the substrate 21 of the ceramic heater 2. An assembly of the substrate green-body halves with the element green-body accommodated therein in a sandwiched condition is subjected to press compression. After the compressed assembly is subjected to a debindering process and a firing process such as hot pressing, the outer circumferential surface of the assembly is polished, whereby the rod-shaped ceramic heater 2 having a hemispherical forward end is formed. The method of manufacturing the ceramic heater 2 may be modified as appropriate. For example, the substrate green-body may be manufactured as follows: one of previously formed substrate green-body halves is placed in a die; the element green-body is placed on the substrate green-body half; the electrically insulating ceramic powder is charged into the die; and press compression is performed.

The ceramic heater 2 is press-fitted into the connection ring 85 formed by forming a steel material, such as stainless steel, into the shape of pipe, thereby establishing electrical connection between the connection ring 85 and the electrode lead portion 26. Similarly, the ceramic heater 2 is press-fitted into the holding member 8 formed into a predetermined shape, thereby establishing electrical connection between the holding member 8 and the electrode lead portion 25. Meanwhile, the center shaft 3 is formed as follows: a rod-shaped member formed by cutting an iron-based material (e.g., Fe—Cr—Mo steel) into a predetermined dimension is subjected to plastic working, cutting, etc. In a state in which the ring engagement portion 34 of the center shaft 3 is engaged with the connection ring 85 fitted to the ceramic heater 2, laser welding is performed along a region where the ring engagement portion 34 and the connection ring 85 are mated, whereby the center shaft 3 and the ceramic heater 2 are united.

The tubular metallic shell 4 is formed from an iron-based material, such as S45C, and threads are formed on the mounting portion 42 by rolling. Furthermore, the taper portion 47 is formed, by cutting or the like, on the wall surface of the axial bore 43 at the rear end portion 45 of the metallic shell 4 such that the diameter of the axial bore 43 decreases from the rear end 48 toward the forward side. The center shaft 3 united to the ceramic heater 2, etc., is inserted through the axial bore 43 of the metallic shell 4. Laser welding is performed along a region where the metallic shell 4 and the holding member 8 are mated, whereby the metallic shell 4 and the holding member 8 are joined together.

Next, the contact member 7 is fitted to the connection end portion 36 of the center shaft 3 projecting from the rear end 48 of the metallic shell 4, and is moved forward. As mentioned above, since the contact member 7 has a symmetrical shape (mirror image) with respect to the axis P and the plane F, the contact member 7 can be fitted to the rear end portion 32 of the center shaft 3 without consideration of the orientation in the direction of the axis P.

As shown in FIG. 5, upon fitting of the contact member 7 to the connection end portion 36 of the center shaft 3, the wall surface of the cylindrical hole 76 comes into contact with the forward end position B1 of the shoulder portion 38 of the center shaft 3. The forward end position B1 corresponds to the boundary between the shoulder portion 38 and the connection base portion 37. The contact member 7 having reached the shoulder portion 38 is pressed further toward the forward side with respect to the direction of the axis O. The diameter C2 of the cylindrical hole 76 of the contact member 7 is rendered greater than the diameter C1 of the connection end portion 36 of the center shaft 3. This decreases the possibility that, when the contact member 7 is fitted to the connection end portion 36, the wall surface of the cylindrical hole 76 and the lock portion 39 of the connection end portion 36 rub against each other, and the cylindrical hole 76 (the inner circumferential surface of the contact member 7) is damaged. The diameter C2 of the cylindrical hole 76 is smaller than the diameter C3 of the connection base portion 37 of the center shaft 3. Therefore, when the contact member 7 having reached the shoulder portion 38 is pressed forward, the diameter of the cylindrical hole 76 is increased due to the taper of the shoulder portion 38.

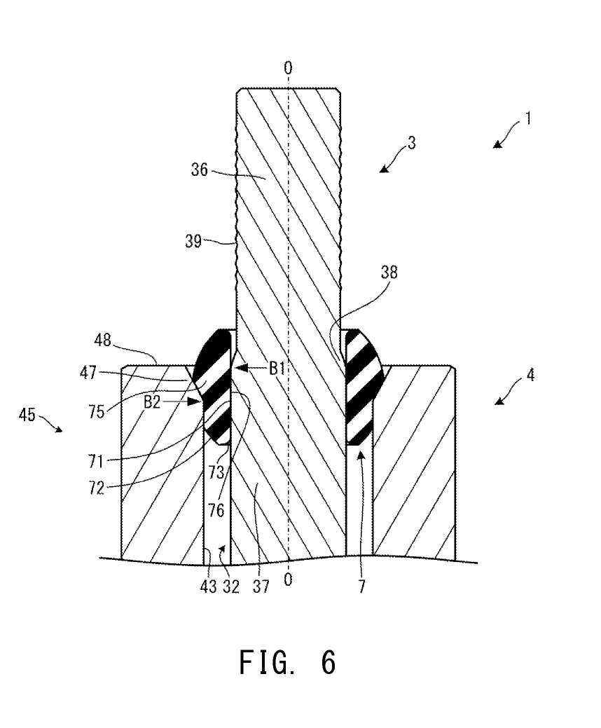

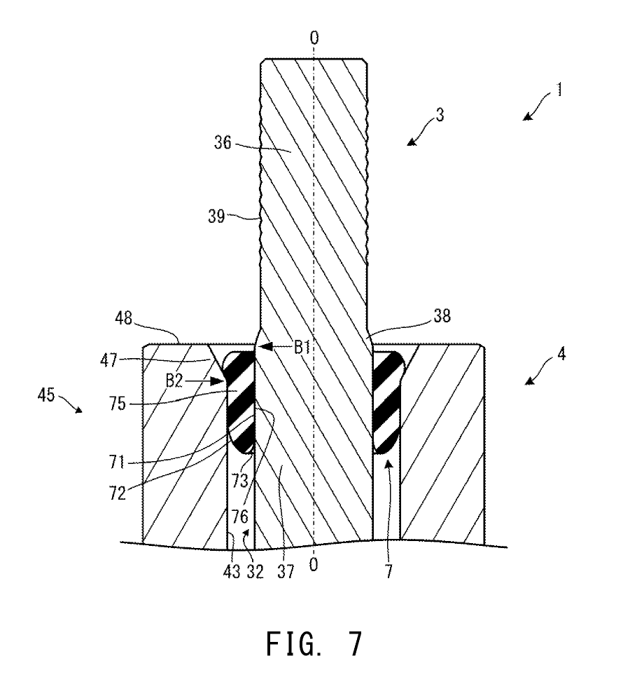

The contact member 7 whose cylindrical hole 76 has been increased in diameter by the shoulder portion 38 is pressed further toward the forward side with respect to the direction of the axis O in a state in which the wall surface of the cylindrical hole 76 is in contact with the outer circumferential surface of the connection base portion 37. As a result, the outer circumferential surface of the contact member 7 comes into contact with the taper portion 47 of the metallic shell 4. When the contact member 7 is pressed toward the forward side with respect to the direction of the axis O in this state, as shown in FIG. 6, the outer circumferential surface side of the contact member 7 elastically deforms to follow the taper of the taper portion 47. A forward end portion of the contact member 7 is inserted into a space located forward of the forward end position B2 of the taper portion 47. As shown in FIG. 7, the contact member 7 having been inserted further toward the forward side with respect to the direction of the axis O maintains, by its elastic deformation, a state in which the contact member 7 is in contact with the wall surface of the axial bore 43 and the connection base portion 37, to thereby ensure the gastightness of the space between the wall surface of the axial bore 43 and the center shaft 3.

After disposition of the contact member 7 between the wall surface of the axial bore 43 and the connection base portion 37, as shown in FIG. 2, the insulation member 6 is fitted to the rear end portion 32 of the center shaft 3 in a state in which the taper portion 63 of the insulation member 6 is in contact with the taper portion 47 of the metallic shell 4 and is positioned. After that, the connection terminal 5 is fitted to the connection end portion 36 of the center shaft 3, and the trunk portion 52 of the connection terminal 5 is crimped, whereby the connection terminal 5 is fixed to the connection end portion 36 of the center shaft 3, and the glow plug 1 is completed.

### Example 1

A test was carried out in order to find the relation between the tan δ of dynamic viscoelasticity of the contact member 7 and the amplitude of the loop of vibration of the center shaft 3 at the time of first resonance. Specifically, there were manufactured a plurality of contact members 7 which had an outer diameter of 3.9 mm, an inner diameter of 1.9 mm, and a height of 3 mm and which had different values of tan δ of dynamic viscoelasticity within a range of 0.01 to 10. The tan δ of dynamic viscoelasticity of the contact member 7 was measured by the following simplified measurement method.

Each of the contact members 7 having different values of tan δ of dynamic viscoelasticity within the range of 0.01 to 10 was assembled to the glow plug 1, and first resonance was produced at the center shaft 3, and the amplitude of the loop of vibration of the center shaft 3 was measured. The measurement of the amplitude of the loop of vibration of the center shaft 3 was performed by forming one or more holes in the metallic shell 4 of the above-mentioned glow plug 1, and applying laser beam to the center shaft 3 through the formed hole(s).

The tan δ of dynamic viscoelasticity of the contact member 7 is determined in a temperature range of 50° C. to 150° C., which is a high temperature region in which the vibration prevention performance of the contact member 7 drops and which range is an assumed temperature range of an environment in which the glow plug 1 is used. The tan δ of dynamic viscoelasticity is determined by using, as an upper limit, 2000 Hz which is the highest frequency of vibration assumed to act on the glow plug 1.

Specifically, the tan δ of dynamic viscoelasticity of the contact member 1 of the glow plug 1 having undergone the measurement of the amplitude of the loop of vibration of the center shaft 3 was measured by the following simplified method. A measurement system 16 reproducing the state of attachment of the contact member 7 in the glow plug 1 (object to be measured) was prepared, and an object to be measured (hereinafter simply referred to as an “object”) was set to the measurement system 16. The measurement system 16 is mainly composed of an object clamping jig 11, a center shaft clamping jig 12, a vibration generator 14, and a laser measurement unit 15. The object clamping jig 11 fixedly holds the outer circumferential surface of the object. The object is the contact member 7 or a reference member. The contact member 7 is one removed from the glow plug 1 having the above-described structure. The reference member is a member which has the same shape as the contact member 7 and whose tan δ of dynamic viscoelasticity is known. There are used a plurality of reference members whose tan δ values are 0.06, 0.13, 0.2, and 0.4, for example. The center shaft clamping jig 12 clamps one end of a center rod corresponding member 13 which is a member corresponding to the center shaft 3. Other end of the center rod corresponding member 13 is clamped by the object clamping jig 11 via the object. A member which was identical to the center shaft 3 in terms of material, outer shape, and length in the direction of the axis O was prepared as the center rod corresponding member 13. The vibration generator 14 is an apparatus configured to generate vibration of a predetermined frequency. The laser measurement unit 15 is an apparatus configured to measure the distance between the unit and an object by making use of reflection of laser beam.

As schematically shown in FIG. 13, the center shaft clamping jig 12 and the object clamping jig 11 were fixed to the top surface of the vibration generator 14. One end of the center rod corresponding member 13 is fixed to the center shaft clamping jig 12. The object clamping jig 11 was disposed such that the distance between the center rod corresponding member 13 and the object clamping jig 11 in the radial direction became equal to the distance, in the radial direction, between the center shaft 3 and the inner circumferential surface of the metallic shell 4 in the glow plug 1. The length of the center rod corresponding member 13 between a position at which the center rod corresponding member 13 was clamped by the center shaft clamping jig 12 and a position at which the object was disposed was made equal to the distance between the rear end of the ceramic heater 2 and a position at which the contact member 7 was disposed. The amplitude of vibration of the center rod corresponding member 13 at the time when vibration was applied to the center rod corresponding member 13 by the vibration generator 14 was measured through use of the laser measurement unit 15.

The contact member 7 removed from the glow plug 1 (object) was set to the measurement system 16 configured as described above, and the center rod corresponding member 13 was vibrated by the vibration generator 14 at the resonance frequency of the center rod corresponding member 13. When the center rod corresponding member 13 was vibrated at the resonance frequency, the laser measurement unit 15 was moved in the longitudinal direction 17 of the center rod corresponding member 13, and a position at which the amplitude of vibration of the center rod corresponding member 13 was the largest was determined, and the amplitude of vibration of the center rod corresponding member 13 was measured at that position. Notably, the measurement was performed in an atmosphere of 100° C. created by heating the object and the object clamping jig 11 by a heater or the like disposed around the object clamping jig 11.

As in the case of the contact member 7, each reference member was set to the measurement system 16 as an object. As in the case of the contact member 7, the amplitude of vibration of the center rod corresponding member 13 when each reference member was set was measured. The amplitude observed when the contact member 7 was used as an object was compared with the amplitudes observed when the reference members were used, and the value of tan δ of the contact member 7 was determined. For example, the amplitude observed when the contact member 7 was used was smaller than the amplitude observed when a reference member whose tan δ value was 0.13 was used and was greater than the amplitude observed when a reference member whose tan δ value was 0.2 was used, the tan δ value of the contact member 7 was determined to be not less than 0.13 but be less than 0.2.

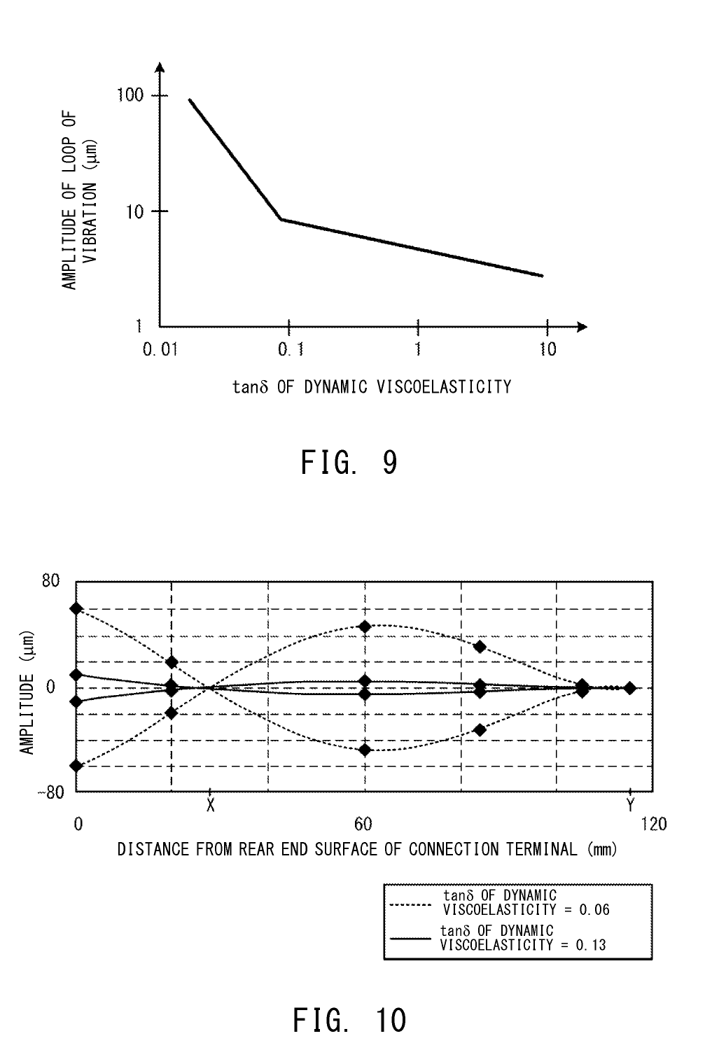

The test results are shown in the double logarithmic graph of FIG. 9. As shown in FIG. 9, it was confirmed that when the tan δ of dynamic viscoelasticity is equal to or greater than 0.1, the amplitude of the loop of vibration of the center shaft 3 at the time of first resonance can be suppressed greatly; i.e., can be suppressed to 10 μm or less.

### Example 2

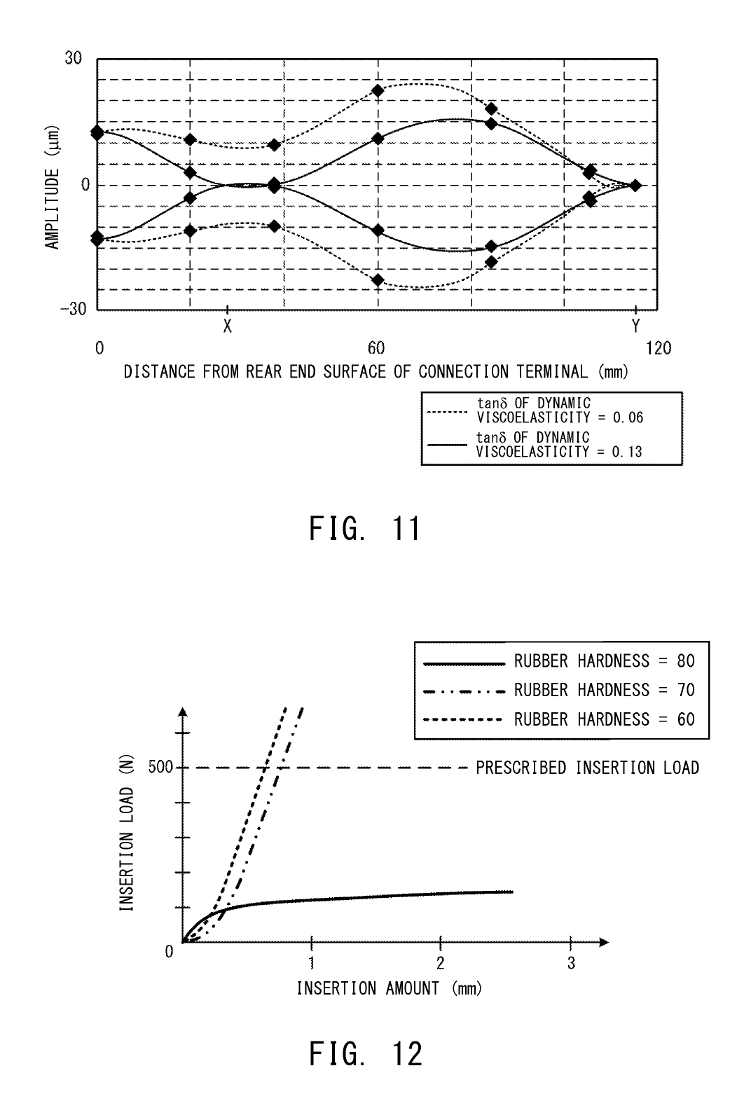

Next, a test was carried out in order to find the relation between the tan δ of dynamic viscoelasticity of the contact member 7 and the amplitude of vibration over the length (in the axial direction) of the center shaft 3 at the time of resonating. Specifically, there were manufactured two contact members 7 which had an outer diameter of 3.9 mm, an inner diameter of 1.9 mm, and a height of 3 mm and whose values of tan δ of dynamic viscoelasticity were 0.06 and 0.13, respectively. Each contact member 7 was assembled to the glow plug 1, and first or second resonance was produced at the center shaft 3, and the amplitudes of vibration of the center shaft 3 and the connection terminal 5 when the center shaft resonated were measured. The method of measuring the amplitudes is the same as that used in Example 1. The test results are shown in the graphs of FIGS. 10 and 11. The horizontal axes of the graphs of FIGS. 10 and 11 show the distance from the rear end surface of the connection terminal 5. X on the horizontal axes show the distance between the rear end surface of the connection terminal 5 and a position X of the contact member 7 (see FIG. 1). Y on the horizontal axes show the distance between the rear end surface of the connection terminal 5 and a position Y at which the center rod 3 is in engagement with the connection ring 85 (see FIG. 1). In FIGS. 10 and 11, the test results for the case where the tan δ of dynamic viscoelasticity was 0.06 are shown by broken lines, and the test results for the case where the tan δ of dynamic viscoelasticity was 0.13 are shown by solid lines.

As shown in FIG. 10, it was confirmed that, in the case where the center shaft 3 resonates at the first resonance frequency, the contact member 7 whose value of tan δ of dynamic viscoelasticity is 0.13 can greatly suppress the amplitude of vibration of the center shaft 3 over the entire length in the direction of the axis O, as compared with the contact member 7 whose value of tan δ of dynamic viscoelasticity is 0.06. As shown in FIG. 11, it was confirmed that, in the case where the center shaft 3 resonates at the second resonance frequency, similarly, the contact member 7 whose value of tan δ of dynamic viscoelasticity is 0.13 can suppress the amplitude of vibration of the center shaft 3, as compared with the contact member 7 whose value of tan δ of dynamic viscoelasticity is 0.06. In addition, the contact member 7 whose value of tan δ of dynamic viscoelasticity is 0.13 can greatly suppress the amplitude at the position where the contact member 7 is disposed to a level at which vibration is hardly observed. It was confirmed that, when the center shaft 3 resonates at the first resonance frequency, the vibration of the center shaft 3 has a single loop which is located in a range H (see FIG. 1) between the position of the contact member 7 and a center position M (see FIG. 1) between the forward end 20 of the ceramic heater 2 and the rear end 35 of the center shaft 3. It was confirmed that, when the center shaft 3 resonates at the second resonance frequency, the vibration of the center shaft 3 has two loops, both of which are located within the range H.

### Example 3

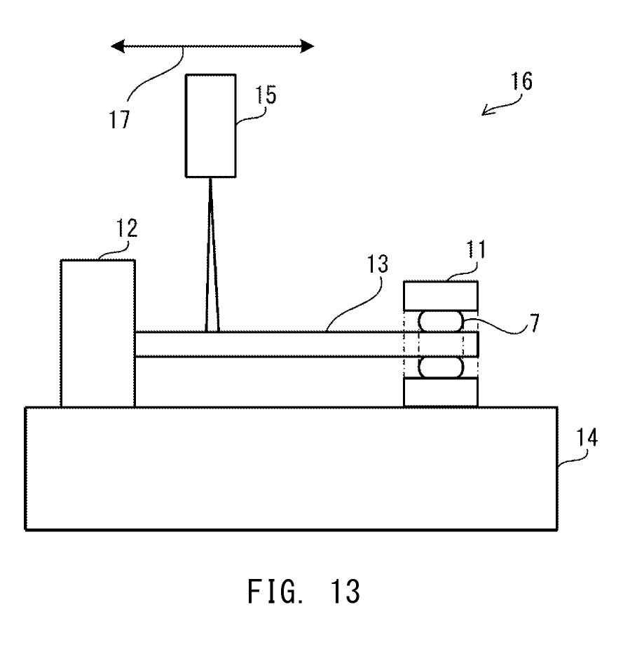

A test was carried out in order to find the relation between the load in the axial direction required to press the contact member 7 into the taper portion 47 and the rubber hardness of the contact member 7. Three contact members 7 having rubber harnesses of 60, 70, and 80, respectively, were manufactured, and, by using a tester for measuring the insertion amount of the contact member 7 and the insertion load, the amount of insertion of the contact member into the taper portion 47 and the insertion load were measured. The test results are shown in the graph of FIG. 12. The insertion amount (the horizontal axis) is measured while the position of the contact member 7 at which the contact member 7 came into contact with the taper portion 47 is used as a reference. In FIG. 12, the test results for the case where the rubber hardness was 60 are shown by a broken line, the test results for the case where the rubber hardness was 70 are shown by a two-dot chain line, and the test results for the case where the rubber hardness was 80 are shown by a solid line.

In the case where the rubber hardness was equal to or less than 70, even when a load equal to or greater than 500 N, which is a prescribed insertion load used in a process of assembling the glow plug 1, was applied, the outer circumferential surface of the contact member 7 was caught by the taper portion 47. As a result, as shown in FIG. 12, the contact member 7 was able to be inserted into the taper portion 47 by an amount of about 1 mm only, and the contact member 7 was not able to be attached. In contrast, in the case where the rubber hardness was 80, the contact member 7 was able to be inserted into an attachment position of the taper portion 47 upon application of an insertion load of about 100 N, which is considerably lower than that used in the case where the rubber hardness was equal to or less than 70. From the above-described results, it was found that the degree of easiness of the operation of attaching the contact member 7 can be increased by setting the rubber hardness of the contact member 7 to 80 or greater.

The above-described glow plug 1 has the following advantageous effects. In the case where the tan δ of dynamic viscoelasticity of the contact member 7 is 0.1 or greater, even when the center shaft 3 resonates due to vibration of an engine (not shown), the amplitude of the vibration of the center shaft 3 can be greatly suppressed. As a result, the amplitude of the vibration of the center shaft 3 is greatly suppressed at the position where the contact member 7 is disposed. Therefore, the instantaneous load acting on the contact member 7 in the radially outward direction decreases, and deterioration (e.g., deformation) of the contact member 7 can be prevented. A glow plug in which the ceramic heater 2 and the center shaft 3 are connected together via the connection ring 85 has a possibility that an internal stress is produced in the ceramic heater 2 due to vibration of the center shaft 3 and the ceramic heater 2 breaks. In the case of the glow plug 1, the internal stress which is produced in the ceramic heater 2 due to vibration of the center shaft 3 can be effectively decreased by setting the tan δ of dynamic viscoelasticity of the contact member 7 to 0.1 or greater, whereby breakage of the ceramic heater 2 can be prevented.

As shown in FIG. 6, when the contact member 7 is inserted into the axial bore 43, the outer circumferential surface of the contact member 7 inserted forward of the forward end position B2 of the taper portion 47 deforms radially inward. Meanwhile, a portion of the outer circumferential surface of the contact member 7 located rearward of the forward end position B2 deforms radially outward, and comes into engagement with the taper portion 47. In the case where the rubber hardness of the contact member 7 falls within the range of 80 to 100, the degree of engagement of the contact member 7 with the taper portion 47 at the time of insertion thereof is smaller as compared with the case where the rubber hardness of the contact member 7 is less than 80, and the contact member 7 is inserted into the axial bore 43, while maintaining the slight engagement with the taper portion 47. Accordingly, in the case where the rubber hardness of the contact member 7 falls within the range of 80 to 100, it is possible to suppress a resistance force whose direction is opposite the insertion direction and which the outer circumferential surface of the contact member 7 receives from the taper portion 47 as a result of the contact member 7 being caught by (coming into engagement with) the taper portion 47, and to suppress torsion of the contact member 7 in the circumferential direction due to the engagement. The circumferential direction refers to a direction in which the contact member 7 rotates about (around) the axis P. As a result, the load for inserting the contact member 7 can be decreased, whereby the degree of easiness of the operation of attaching the contact member 7 can be increased.

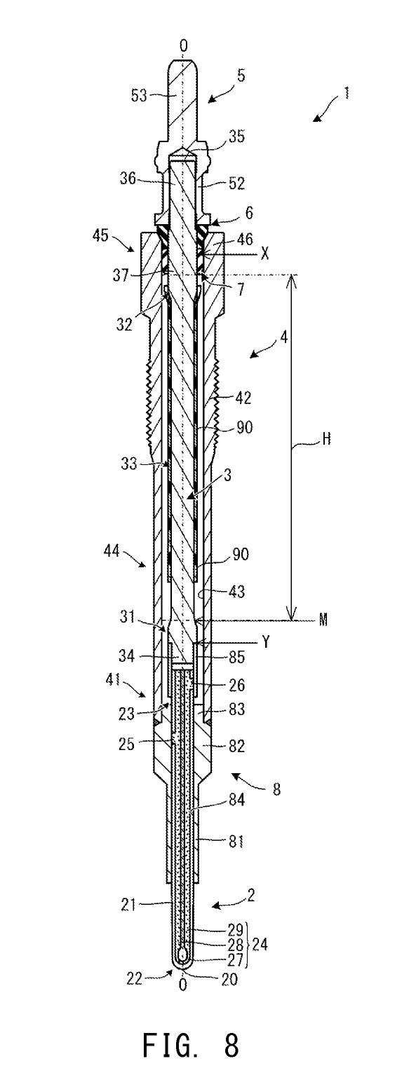

The present invention may be modified in various ways. For example, a vibration prevention member may be disposed such that, in the direction of the axis O, at least a portion of the vibration prevention member is disposed in the range H between the contact member 7 and the center position M between the forward end 20 of the ceramic heater 2 and the rear end 35 of the center shaft 3. More specifically, as shown in FIG. 8, a cylindrical tubular vibration prevention member 90 is disposed to cover the intermediate trunk portion 33 and the rear end portion 32 of the center shaft 3 of the glow plug 1 of the above-described embodiment. The vibration prevention member 90 is formed by insert molding or a like method, and the tan δ of dynamic viscoelasticity of the vibration prevention member 90 is equal to or greater than 0.1 in the temperature range of 50° C. to 150° C. In FIG. 8, members identical to those of the glow plug 1 of FIG. 1 are denoted by the same reference numerals. The length and position of the vibration prevention member 90 in the direction of the axis O may be set in consideration of the position of the loop of vibration of the center shaft 3 within an expected vibration range. As described above, in the case where the center shaft 3 resonates (more specifically, resonates at the first resonance frequency or the second resonance frequency), the loop of vibration is located between the position of the contact member 7 and the center position M between the forward end portion 22 of the ceramic heater 2 and the rear end 35 of the center shaft 3 in the direction of the axis O. Accordingly, by disposing at least a portion of the vibration prevention member 90 within the range H, the amplitude of the vibration of the center shaft 3 when it resonates can be suppressed. In the case where the vibration prevention member 90 is disposed such that, in the direction of the axis O, at least a portion of the vibration prevention member 90 is disposed in the range H between the contact member 7 and the center position M between the forward end 20 of the ceramic heater 2 and the rear end 35 of the center shaft 3, the vibration prevention member 90 may be disposed in a portion of the range H in the direction of the axis O. Alternatively, the vibration prevention member 90 may be disposed to extend over the entire range H. The vibration prevention member 90 may have the form of a tube, and may be disposed between the center shaft 3 and the wall surface of the axial bore 43. In this case as well, a similar vibration prevention effect can be obtained. The cross section of the vibration prevention member 90 taken perpendicularly to the axis O may have a non-circular shape such as a C-like shape.

The glow plug of the above-described embodiment may be modified by providing taper portions on the center shaft 3 and the wall surface of the axial bore 43 with which the contact member 7 comes into contact. In this case, since the contact member 7 is pressed against the taper portions by the forward end surface of the insulation member 6, the contact member 7 tightly contacts, through three contact surfaces, with the wall surface of the axial bore 43, the center shaft 3, and the insulation member 6. Therefore, the gastightness of the space between the wall surface of the axial bore 43 and the center shaft 3 can be maintained. At the same time, since the tan δ of dynamic viscoelasticity of the contact member 7 is 0.1 or greater, the amplitude of vibration of the center shaft 3 when it resonates is suppressed greatly as in the case of the above-described embodiment, and the glow plug 1 can prevent deterioration of the contact member 7.

In the above-described embodiment, the present invention is applied to a glow plug in which the ceramic heater 2 and the center shaft 3 are connected together via the connection ring 85. However, the present invention may be applied to a glow plug in which the ceramic heater 2 and the center shaft 3 are electrically connected via a metal wire. In the case of such a glow plug, an internal stress is produced in the metal wire as a result of vibration of the center shaft 3 and the metal wire may be broken. However, by setting the tan δ of dynamic viscoelasticity of the contact member 7 to 0.1 or greater, the glow plug 1 can effectively decrease the internal stress which is produced in the metal wire due to vibration of the center shaft 3, and can prevent breakage of the metal wire.

The material, shape, and position of the contact member 7 may be changed freely. For example, the second contour segment 71 may assume the form of a curve which has a radius R2 of curvature and swells radially inward. In this case, preferably, the radius R1 of curvature is smaller than the radius R2 of curvature. By virtue of this configuration, when the contact member is disposed between the wall surface of the axial bore 43 and the center shaft 3, the first contour segment 72 which swells more than the second contour segment 71 can be elastically deformed smoothly. In the glow plug 1, the second contour segment 71, which swells less than the first contour segment 72 and has a shape closer to a straight line, can be caused to function as a core which supports the entirety of the contact member to thereby prevent the contact member from bending or being dragged inward.

Notably, in the present embodiment, the ceramic heater 2 corresponds to the “heater.”

1. A glow plug comprising:
a heater which has a heat-generating resistor in a forward end portion thereof, the heat-generating resistor generating heat when energized;
a tubular metallic shell which has an axial bore extending in a direction of an axis of the metallic shell and which directly or indirectly holds the heater in a forward end portion of the metallic shell;
a rod-shaped center shaft which is disposed in the metallic shell such that a gap is formed between the center shaft and an inner circumferential surface of the metallic shell, the center shaft having a forward end portion connected to a rear end portion of the heater, and a rear end portion projecting from a rear end of the metallic shell; and
an annular contact member which is formed of an insulating viscoelastic material and which is inserted into the axial bore at a rear end portion of the metallic shell and is disposed in a state in which the contact member is in contact with the inner circumferential surface of the metallic shell and the center shaft,
wherein the tan δ of dynamic viscoelasticity of the contact member within a temperature range of 50° C. to 150° C. is equal to or greater than 0.1.

2. A glow plug according to claim 1, wherein the contact member has a rubber hardness of 80 to 100.

3. A glow plug according to claim 1, wherein a vibration prevention member which is provided separately from the contact member and whose tan δ of dynamic viscoelasticity within a temperature range of 50° C. to 150° C. is equal to or greater than 0.1 is disposed in the gap.

4. A glow plug according to claim 3, wherein, as viewed in the direction of the axis, at least a portion of the vibration prevention member is disposed in a region between the contact member and a center position between a forward end of the heater and a rear end of the center shaft.

5. A glow plug according to claim 1, wherein the contact member is mainly formed of fluorocarbon rubber.

6. A glow plug according to claim 1, wherein
a contour of one of two cross sections of the contact member obtained by cutting the contact member in a state prior to attachment to the glow plug by a plane which contains a second axis which is the axis of the contact member has
a first contour segment assuming the form of a curve extending along the second axis and swelling radially outward with a radius R1 of curvature, and
a second contour segment assuming the form of a straight line extending along the second axis or the form of a curve extending along the second axis and swelling radially inward with a radius R2 of curvature which satisfies a relational expression R1<R2.
